(19) United States
(12) Patent Application Publication
(10) Pub. No.: US 2016/0292627 A1
(43) Pub. Date: Oct. 6, 2016

(54) MAINTENANCE MANAGEMENT DEVICE, MAINTENANCE MANAGEMENT METHOD AND PROGRAM

(71) Applicant: MITSUBISHI HEAVY INDUSTRIES, LTD., Tokyo (JP)

(72) Inventor: Takeaki YAMADA, Tokyo (JP)

(21) Appl. No.: 15/038,311

(22) PCT Filed: Dec. 22, 2014
(86) PCT No.: PCT/JP2014/083870

§ 371 Date: May 20, 2016

(30) Foreign Application Priority Data
Jan. 22, 2014 (JP) 2014-009681

(51) Int. Cl. G06Q 10/08

(52) U.S. Cl. CPC G06Q 10/087; G06Q 50/30

(57) ABSTRACT

This maintenance management device is provided with a maintenance target device candidate determination unit which determines a maintenance target device candidate in a maintenance segment based on an operation mode determined for a track running vehicle system, and an output unit which outputs the determined maintenance target device candidate. Further, for each maintenance target device, the output unit outputs the time, number of worker, cost, etc., needed for maintenance operations, and supports the user in planning maintenance operations.

### TECHNICAL FIELD

The present invention relates to a maintenance management device, a maintenance management method and a program.

This application is based upon and claims the benefit of priority from Japanese Patent Application No. 2014-009681; filed Jan. 22, 2014; the entire contents of which are incorporated herein by reference.

### BACKGROUND ART

In public transportation, it is necessary to execute maintenance or inspection while rigidly observing a predetermined inspection cycle. If a regular inspection is neglected, an unexpected accident may occur due to the consumption of components, or such negligence is punishable by law.

Incidentally, in order to draft a maintenance and inspection operation plan, a planner needs to consider various conditions. For example, the planner needs to ascertain a device that meets an inspection deadline and a position where this device is provided to manage whether or not there is inventory of a component capable of replacing this device or component. The planner needs to ascertain whether or not there is a position where a failure occurs, even during a period other than the inspection cycle, based on past failure history to execute a detailed inspection such as an overhaul on a device in which failures frequently occur as early as possible. The planner also needs to check whether or not the operation can be executed on the inspection position based on an operation schedule in a case where a maintenance operation is executed, or secure workers. The planner also needs to consider costs required for the maintenance operation. For example, if the relationship between an operation service and a maintenance position is considered, it is appropriate to execute maintenance in the night when a vehicle operation service is not provided. However, in the case of the night operation, a labor unit cost of workers is high and a facility, such as an illumination lamp in preparation for the darkness, needs to be temporarily provided, and thus the night operation incurs higher costs than a day operation.

For example, PTL 1 describes a method of calculating the degree of damage to a structure based on information detected by a sensor provided at the structure in a segment in which a railway is operated in a case where a maintenance inspection of a railway structure is performed and determining the priority order of operations in consideration of a social influence caused by stoppage of a train.

### CITATION LIST

### Patent Literature

[PTL 1] Japanese Unexamined Patent Application Publication No. 2011-192110

### SUMMARY OF INVENTION

### Technical Problem

In the past, in a case where the maintenance operation of the public transportation is planned, even though there are data items such as an operation schedule, failure history of components, inventory management of components, attendance and absence management of workers, fare income, and cost required for maintenance, it is difficult to efficiently plan the maintenance operation by these data items.

The present invention provides a maintenance management device, a maintenance management method and a program capable of solving the above-described problems.

### Solution to Problem

According to a first aspect of the present invention, a maintenance management device includes a maintenance target device candidate determination unit that determines maintenance target device candidates in a maintenance segment based on an operation mode determined for the track running vehicle system, and an output unit that outputs the determined maintenance target device candidates.

According to a second aspect of the present invention, the maintenance management device may further include an operating rate calculation unit that calculates an operating rate of each maintenance target device candidate based on past operation time and failure history. The output unit may output the operating rate of each maintenance target device candidate.

According to a third aspect of the present invention, the maintenance management device may further include a cost information calculation unit that calculates cost information based on maintenance cost of a maintenance target device selected from the maintenance target device candidates. The output unit may output the maintenance cost and the cost information of each maintenance target device candidate.

According to a fourth aspect of the present invention, in the maintenance management device, the output unit may obtain an inspection deadline of each maintenance target device candidate, and may output the obtained inspection deadline.

According to a fifth aspect of the present invention, in the maintenance management device, the output unit may rearrange the maintenance target device candidates based on at least one of the operating rate, the maintenance cost and the inspection deadline, and may display the rearranged maintenance target device candidates.

According to a sixth aspect of the present invention, in the maintenance management device, the output unit may obtain the amount of inventory of each maintenance target device candidate, and may output the obtained amount of inventory.

According to a seventh aspect of the present invention, in the maintenance management device, the output unit may obtain time and the number of workers required for maintenance of each maintenance target device candidate, and may output the obtained time and number of workers.

According to an eighth aspect of the present invention, the maintenance management device may further include an operation mode candidate determination unit that determines candidates of the operation mode indicating a vehicle operation mode in a predetermined operation segment and a predetermined operation time zone. The output unit may output the candidates of the operation mode in the predetermined operation segment and the predetermined period.

According to a ninth aspect of the present invention, in the maintenance management device, the output unit may perform display such that an operation route and a maintenance segment are different for an operation mode selected from the candidates of the operation mode.

According to a tenth aspect of the present invention, the maintenance management device may further include a maintenance plan recording unit that records information including the maintenance target device selected for each operation mode and the maintenance cost and the number of workers for the maintenance target device. The output unit may obtain the information recorded by the maintenance plan recording unit, and may output the achievement of the inspection deadline which is previously determined for each maintenance target device candidate and total income and expenditure calculated using a fare income, operation cost and maintenance cost for a predetermined period.

According to an eleventh aspect of the present invention, a maintenance management method includes determining maintenance target device candidates in a maintenance segment based on an operation mode determined for the track running vehicle system, and outputting the determined maintenance target device candidates.

According to a twelfth aspect of the present invention, a program causing a computer of a maintenance management device to function as means for determining maintenance target device candidates in a maintenance segment based on an operation mode determined for a track running vehicle system, and means for outputting the determined maintenance target device candidates.

### Advantageous Effects of Invention

According to the above-described aspects of the present invention, it is possible to efficiently perform a maintenance operation plan.

### BRIEF DESCRIPTION OF DRAWINGS

FIG. 1 is a functional block diagram of a maintenance management device according to a first embodiment of the present invention.

FIG. 2 shows an example of an operation mode candidate display screen according to the first embodiment of the present invention.

FIG. 3 shows an example of a maintenance target candidate display screen according to the first embodiment of the present invention.

FIG. 4 is a flowchart showing a process of selecting a maintenance target according to the first embodiment of the present invention.

FIG. 5 shows an example of a maintenance plan list according to the first embodiment of the present invention.

### DESCRIPTION OF EMBODIMENTS

### First Embodiment

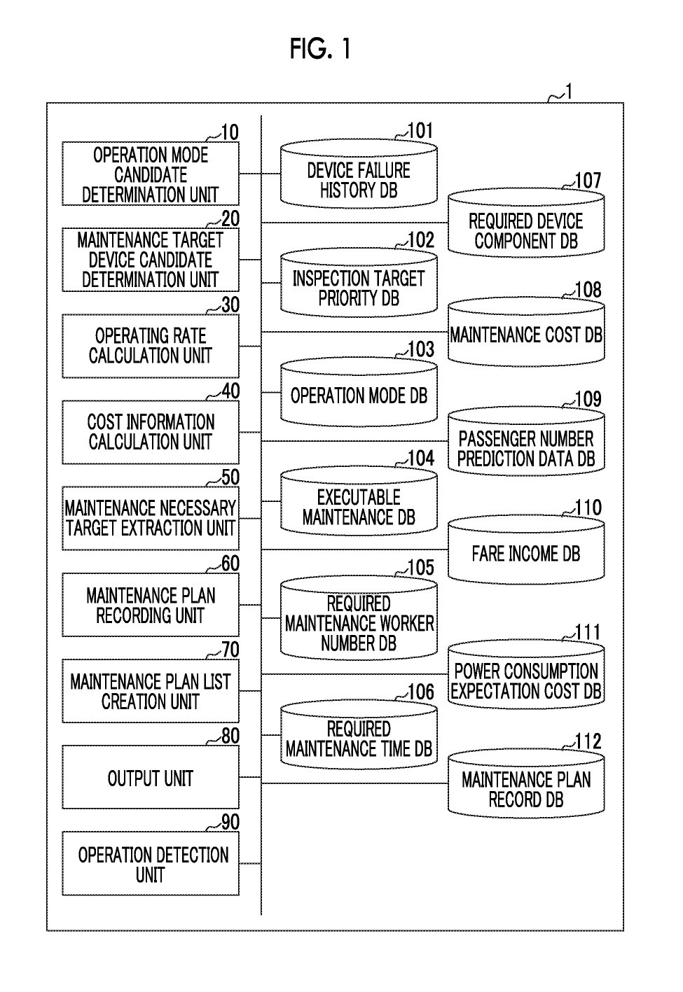

Hereinafter, a maintenance management device according to a first embodiment of the present invention will be described with reference to FIGS. 1 to 5.

FIG. 1 is a functional block diagram of a maintenance management device according to the first embodiment.

Reference numeral 1 of FIG. 1 denotes a maintenance management device of a track running vehicle system. The track running vehicle system refers to a transportation system in which a vehicle such as a train or a bus runs on a predetermined track. As shown in FIG. 1, the maintenance management device 1 according to the present embodiment includes, a operation mode candidate determination unit 10, a maintenance target device candidate determination unit 20, an operating rate calculation unit 30, a cost information calculation unit 40, a maintenance necessary target extraction unit 50, a maintenance plan recording unit 60, a maintenance plan list creation unit 70, an output unit 80, a device failure history DB 101, an inspection target priority DB 102, an operation mode DB 103, an executable maintenance DB 104, a required maintenance worker number DB 105, a required maintenance time DB 106, a required device component DB 107, a maintenance cost DB 108, a passenger number prediction data DB 109, a fare income DB 110, a power consumption expectation cost DB 111, and a maintenance plan record DB 112.

The operation mode candidate determination 10 reads yield data of the number of passengers in the past from the passenger number prediction data DB 109, and calculates an operation route of a vehicle, a vehicle organization number, an operation interval in a predetermined operation segment and a predetermined period (for example, one day or a certain time zone). For example, the operation mode candidate determination unit 10 reads operation mode candidates capable of satisfying transportation capacity required for one day (passengers per hour per direction (PPHPD)) from the operation mode DB 103, and outputs the read operation mode candidates to the output unit 80. The operation mode is a vehicle operation mode in which an operation route, operation time zone and operation time interval of the vehicle are determined.

The maintenance target device candidate determination unit 20 reads devices or components on which maintenance can be executed in the respective operation mode candidates determined by the operation mode candidate determination unit 10 from the executable maintenance DB 104, and outputs the read devices or components to the operating rate calculation unit 30, the cost information calculation unit 40, and the output unit 80. The device or component on which maintenance can be executed refers to a device or component provided in a segment in which the vehicle is not operated in a predetermined time zone in each operation mode.

The operating rate calculation unit 30 calculates an operating rate of each device or component output by the maintenance target device candidate determination unit 20. Specifically, the operating rate calculation unit 30 calculates an operation time of a device or component that is currently used from a use start timing (replacement timing) of each device included in the inspection target priority DB 102. The operating rate calculation unit 30 reads the number of failures occurring in the currently used device or component up to the present from the use start timing from the device failure history DB 101. The operating rate calculation unit 30 calculates mean time between failures (MTBF) for each device or component by MTBF=operation time/number of failures. Subsequently, the operating rate calculation unit 30 reads time required to repair each device or component at the time of failure from the device failure history DB 101, and calculates mean time to repair (MTTR) which is an average value. The operating rate calculation unit 30 calculates an operating rate by operating rate=MTBF/(MTBF+MTTR), and outputs the calculated operating rate to the output unit 80.

The cost information calculation unit 40 reads cost information items of devices or components, which are selected from the maintenance target device candidates by a user, from the maintenance cost DB 108, and adds these cost items together. The cost information calculation unit 40 reads a fare in a segment indicated by the operation mode selected by the user from the fare income DB 110. The cost information calculation unit 40 reads prediction values of the number of passengers from the passenger number prediction data DB 109. The cost information calculation unit 40 calculates a fare income by multiplying the read prediction values together. The cost information calculation unit 40 reads cost information due to power consumption in a case where the vehicle is operated in the operation mode selected by the user from the power consumption expectation cost DB 111. The cost information calculation unit 40 subtracts the added maintenance cost and power consumption cost from the calculated fare income, calculates income and expenditure of funds in a case where the operation mode is used, and outputs the calculated income and expenditure of funds to the output unit 80.

The maintenance necessary target extraction unit 50 extracts devices or components that meet an inspection deadline within a predetermined period from the inspection target priority DB 102. The maintenance necessary target extraction unit 50 extracts devices or components in which the number of failures in a predetermined recent period is large from the device failure history DB 101. The maintenance necessary target extraction unit 50 outputs information regarding the extracted devices or components to the output unit 80.

The maintenance plan recording unit 60 records a device or component which is determined as a maintenance target by the user in the operation mode selected by the user, maintenance cost, and the number of maintenance workers or an operation time required to execute a maintenance operation for each operation mode in the maintenance plan record DB 112.

The maintenance plan list creation unit 70 reads the information recorded in the maintenance plan record DB 112, generates a list of maintenance operations in a predetermined period, and outputs the generated list to the output unit 80.

The output unit 80 displays information regarding maintenance of devices or components provided in facilities of the means of transportation on a display of the maintenance management device.

An operation detection unit 90 detects an input operation of the user through a mouse or keyboard, and obtains operation instruction information.

The device failure history DB 101 stores information regarding the failure history of the devices or components. For example, a failure occurrence date and time, influence, causes of the failure, countermeasures, and time required for recovery are included in the failure history.

The inspection target priority DB 102 stores information regarding the next inspection deadline based on an inspection cycle determined for each device or component. An inspection cycle such as every six month or every year is determined for each device or component by law or a self-governing inspection rule, and the inspection target priority DB 102 stores at least an inspection due date which meets next.

The operation mode DB 103 stores operation modes that determine vehicle operation methods. The operation mode includes information items such as the operation route of the vehicle, the vehicle organization number, the operation interval, and the operation time zone. For example, on the assumption that operation routes from a station “M1” to a station “M2” are “a”, “b” and “c”, six vehicles or eight vehicles can be organized, and the vehicles can be operated at an operation interval of 5 minutes or 10 minutes, there are formally 12 (3×2×2) operation modes. Operation modes in which the vehicles can be operated in actuality, among these modes, are stored in the operation mode DB 103.

The executable maintenance DB 104 stores devices or components on which a maintenance operation can be executed in each operation mode.

The required maintenance worker number DB 105 stores the number of workers required for maintenance for each device.

The required maintenance time DB 106 stores time required for a maintenance operation for each device.

The required device component DB 107 stores the inventory amount or purchase date of each device or component.

The maintenance cost DB 108 stores cost information required for maintenance on each device. Labor cost or cost of articles required for an operation is included in the maintenance cost.

The passenger number prediction data DB 109 stores a passenger prediction number in a predetermined segment. For example, the passenger prediction number may be the number of passengers who get on or off the vehicle in each station in a predetermined past period.

The fare income DB 110 stores a fare between the respective stations. It is possible to calculate a prediction fare income in the segment by multiplying the passenger prediction number of the passenger number prediction data DB 109 and the fare of the fare income DB 110.

The power consumption expectation cost DB 111 stores a power consumption expectation value in each operation mode. It is possible to calculate electric charges generated by the vehicle operation by multiplying the power consumption expectation value and the electric charges.

The maintenance plan record DB 112 stores the operation mode selected by the user in association with the device as the maintenance target selected by the user in the selected operation mode, the cost information, and the required worker number. For example, it is possible to ascertain the cost or the number of workers required for maintenance up to one month ago based such information.

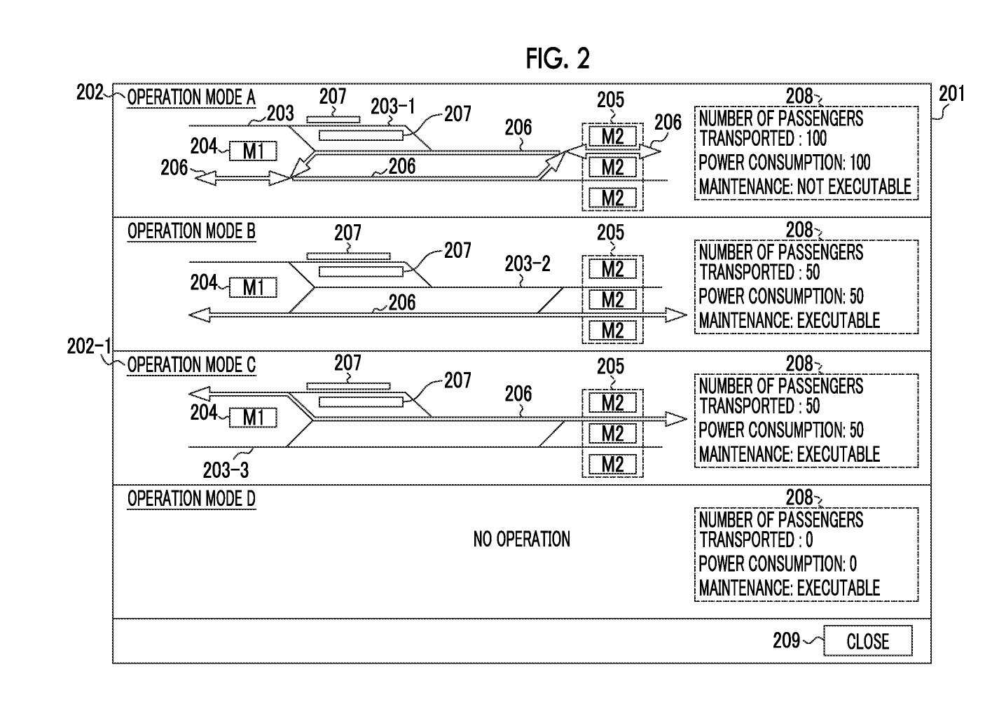

FIG. 2 shows an example of an operation mode candidate display screen according to the first embodiment of the present invention.

The operation mode candidate display screen according to the present embodiment will be described with reference to FIG. 2.

FIG. 2 shows an operation mode candidate display screen 201. For example, the operation mode candidate display screen 201 is a screen displayed on the display if the user designates a condition such as an operation segment of a vehicle, an operation date, an operation time zone, or a required transportation capacity. In the following description, the screen refers to screen information displayed on the display. If the user designates the condition such as the operation segment, the operation mode candidate determination unit 10 reads and extracts the operation mode that satisfies the conditions from the operation mode DB 103 by using the conditions designated by the operation mode candidate determination unit 10. The operation mode that satisfies the condition may be one or plural.

The operation mode candidate determination unit 10 outputs the extracted operation mode information to the output unit 80, and the output unit 80 displays the output operation mode information on the display.

FIG. 2 shows a name of the operation mode 202 that satisfies the condition designated by the user. In the example of FIG. 2, “Operation Mode A”, “Operation Mode B”, “Operation Mode C” and “Operation Mode D” are displayed.

FIG. 2 shows a route 203 on which the vehicle is operated.

FIG. 2 shows stations 204 and 205 at which the vehicle stops. FIG. 2 shows a “M1” station 204 and a “M2” station 205.

A double-lined arrow indicates a route 206 on which the vehicle is operated in each operation mode.

FIG. 2 shows a construction segment 207. In the case of FIG. 2, the vehicle is not operated in a route 203-1.

In an area 208, the number of passengers transported when the vehicle is operated on the route 206, power consumption required for the operation, and whether or not maintenance is executable are displayed. These information items are retained in the operation mode DB 103. A time zone in which the vehicle can be operated may be displayed in the area 208. For example, the required transportation capacity and the operation time interval of the vehicle are different between rush hour and daytime in some cases. In such a case, for example, in “Operation Mode A”, if the vehicle can be operated at only from 7 a.m. to 9 a.m., “from 7 a.m. to 9 a.m.” may be displayed in the area 208 of “Operation Mode A”. In a case where there are devices or components which meet an inspection deadline within a predetermined period, among the devices or components provided in the segment in which the maintenance operation, can be executed in the operation mode, a message such as “there are devices requiring maintenance” for attracting attention may be displayed in the area 208. Since the number of devices or components as the maintenance targets is enormous, it is possible to ascertain the device or component which meets the inspection deadline by performing such display, and it is expected that the damage to the component or device will be prevented.

FIG. 2 shows a “close” button 209. If the user stops browsing, the user stops the screen by pressing the button 209. For example, in a case where there are many operation modes as candidates, a “next” button may be displayed next to the “close” button 209, and the candidates of the operation modes that are not displayed on page 1 may be displayed by displaying the next page.

The respective operation modes will be described.

In “Operation Mode A”, the vehicle is operated on the route 206. In such a case, it is difficult to execute maintenance on the route 206 in terms of safety or operational efficiency. As described above, the segment 203-1 is under construction, and this segment does is hard to serve as the maintenance target. Accordingly, “maintenance: not executable” is displayed in the area 208.

Meanwhile, In “Operation Mode B” or “Operation Mode C”, the vehicle is not operated in a segment 203-2 and a segment 203-3, and these segments are not under construction. Accordingly, the maintenance operation can be executed in these segments, and “maintenance: executable” is displayed in the areas 208 of “Operation Mode B” and “Operation Mode C”.

“Operation Mode D” is a display example in a case where the vehicle is not operated. In this case, since the vehicle is not operated in a segment that is not under circumstances such as under construction, the maintenance operation can be executed in this segment. Accordingly, “maintenance: executable” is displayed in the area 208 of “Operation Mode D”.

The user distinguishes between the operation mode including the segment in which the maintenance operation can be executed and the operation mode not including the segment in which the maintenance operation can be executed by referring to the operation mode candidate display screen 201 shown in FIG. 2, and can select the operation mode in which the maintenance can be executed while securing the required transportation quantity. Accordingly, the user can execute the maintenance operation which has been executed in the night when high cost is needed in the daytime.

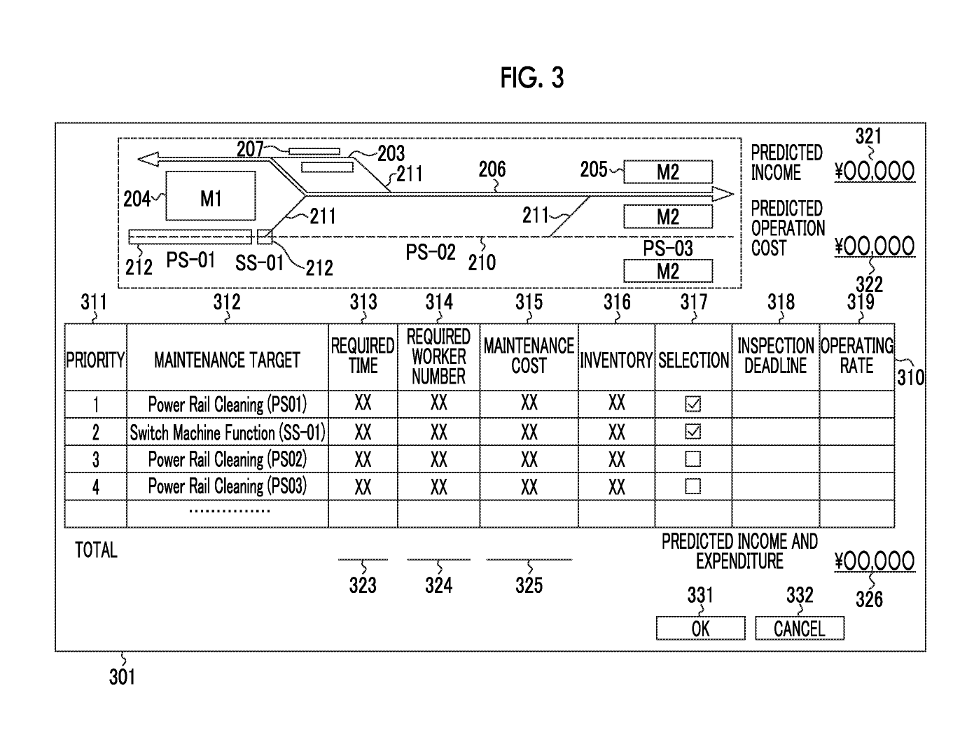

Hereinafter, a screen used to draft a maintenance operation plan in a case where the user performs the selection such that the vehicle is operated in “Operation Mode C” in order to use the segment 203-3 as the maintenance target will be described in more detail with reference to FIG. 3.

FIG. 3 shows an example of a maintenance target candidate display screen according to the first embodiment of the present invention.

The maintenance target candidate display screen according to the present embodiment will be described with reference to FIG. 3. The same display items as those in FIG. 2 will be assigned by being assigned the same reference numerals.

FIG. 3 shows a maintenance target candidate display screen 301. For example, the user presses a portion of “Operation Mode C” 202-1 on the screen of FIG. 2, and thus, the maintenance target candidate display screen 301 may be displayed. This screen is a screen on which the output unit 80 displays the information, which is read by the maintenance target device candidate determination unit 20 from the executable maintenance DB 104 by using the operation mode designated by the user, on the display.

FIG. 3 shows a segment (maintenance segment) 210 in which the maintenance can be executed. The output unit 80 displays a maintenance segment in a state different from the state of the operation route (reference numeral 206) of the vehicle or other segments (segments 203 and 211). For example, the output unit 80 may display the maintenance segment 210 in a different color, or may display the maintenance segment by using a broken line shown in FIG. 3. The user can ascertain the maintenance segment at first glance.

The vehicle is not operated in the segment 211, but is a segment other than the maintenance segment in consideration of safety.

FIG. 3 shows a list 310 that displays the candidates of the maintenance target devices.

The list 310 includes a “priority” row 311. The output unit 80 numbers priorities when the candidates are rearranged based on the operating rate, maintenance cost or inspection deadline from 1 in order, and outputs the numbered priorities to the row 311.

The list 310 includes a “maintenance target” row 312. The output unit 80 outputs maintenance operation items related to the devices or components provided in the maintenance segment 210 to the row 312. The maintenance operation item is information read by the maintenance target device candidate determination unit 20 from the executable maintenance DB 104. The user can check an operation required for each device or component.

The list 310 includes a “required time” row 313. The output unit 80 outputs time required for each maintenance operation read by the maintenance target device candidate determination unit 20 from the required maintenance time DB 106 to the row 313. The user can ascertain the time required for the operation by checking the value of this field.

The list 310 includes a “required worker number” row 314. The output unit 80 outputs the number of workers required for each maintenance operation read by the maintenance target device candidate determination unit 20 from the required maintenance worker number DB 105 to the row 314. The user can ascertain the number of workers required for the operation by checking the value of this field.

The list 310 includes a “maintenance cost” row 315. The output unit 80 outputs cost required for each maintenance operation read by the maintenance target device candidate determination unit 20 from the maintenance cost DB 108 to the row 315. The user can ascertain cost required for maintenance by checking the value of this field. The cost is the labor cost of the required worker or the costs of the articles used in the operation.

The list 310 includes an “inventory” row 316. The output unit 80 outputs whether or not there is inventory of the device or component required for each maintenance read by the maintenance target device candidate determination unit 20 from the required device component DB 107 to the row 316. The user may determine whether or not to execute the maintenance operation depending on the whether or not there is inventory of the device by checking the inventory of the device required for the operation by checking the value of this field, or may order the component if necessary.

The list 310 includes a “selection” row 317. For example, the output unit 80 displays a check box in the row 317. The user determines an item on which maintenance is executed by checking another field of the list 310, and gives a check mark in the “selection” field of the item (column) on which the operation is executed. If the user gives the check mark, the cost information calculation unit 40 calculates cost, or the output unit 80 displays a target portion of the maintenance operation so as to be distinguishable from other portions. Reference numeral 212 denotes a target portion of the maintenance operation of which the check mark is given to the “selection” field by the user. The output unit 80 displays the target portion of the maintenance operation so as to be different from other portions. For example, as shown in FIG. 3, the output unit 80 may display the portion such that the portion is surrounded by a square, may display the portion in a color different from those of other portions, or may blink the portion.

The list 310 includes an “inspection deadline” row 318. The output unit 80 outputs the inspection deadline determined for each maintenance operation item read by the maintenance target device candidate determination unit 20 from the inspection target priority DB 102 to the row 318. The user can ascertain the operation item which urgently requires maintenance by checking the date of this row.

The list 310 includes an “operating rate” row 319. For example, the operating rate calculation unit 30 calculates an operating rate from the above-described expression by using the failure history for each device or component of each maintenance target read from the device failure history DB 101 and the use start timing of each device read from the inspection target priority DB 102 by the maintenance target device candidate determination unit 20. The output unit 80 displays the operating rate calculated by the operating rate calculation unit 30 in the row 319. The user can distinguish between the target in which many failures occur and which early requires maintenance and the target of which the operating rate is high and in which the inspection can be performed later by checking the value of this row.

Among these rows, if the user presses header columns (first columns) of the respective rows, the output unit 80 may rearrange the respective rows of “maintenance cost”, “inspection deadline” and “operating rate” using the respective items as a key, and may redisplay the list 310 by using the rearranged information items.

The list 310 includes a field 321 that displays a prediction income of the fare income in a case where the vehicle is operated in the operation mode displayed on the screen. For example, the prediction income is calculated by multiplying the fare information read from the fare income DB 110 and the passenger number read from the passenger number prediction data DB 109 by the maintenance target device candidate determination unit 20, and the output unit 80 displays the calculated prediction income.

The list 310 includes a field 322 that displays predicted operation cost due to the power consumption and the labor cost in a case where the vehicle is operated in the operation mode displayed on the screen. For example, the predicted operation cost is a value obtained by adding values, which are obtained by multiplying the labor cost in the operation mode read from the operation mode DB 103 and the expected power consumption read from the power consumption expectation cost DB 111 when the vehicle is operated in the operation mode by the maintenance target device candidate determination unit 20 by the electric charges, and the output unit 80 displays the added value.

The list 310 includes a field 323 that displays the total time which is required for the maintenance operations of the columns in which the user gives the check mark to the “selection” row and is calculated by the output unit 80.

The list 310 includes a field 324 that displays the total number of worker which is required for the maintenance operations of the columns in which the user gives the check mark to the “selection” row and is calculated by the output unit 80.

The list 310 includes a field 325 that displays the total maintenance cost which is required for the maintenance operations of the columns in which the user gives the check mark to the “selection” row and is calculated by the output unit 80.

The list 310 includes a field 326 that displays the predicted income and expenditure amount in a case where the maintenance operation selected on the screen by the user is executed and is calculated by the output unit 80. Specifically, the output unit 80 obtains this value by subtracting the value of the predicted operation cost field 322 and the value of the total maintenance cost field 325 from the value of the prediction income field 321. The user can select the maintenance target such that a deficit due to the maintenance operation is prevented by checking the value of this field. For example, in a case where the vehicle is operated in one operation mode for a day, the user can draft the maintenance plan while checking income and expenditure in a day by referring to the screen of FIG. 3 for the operation mode.

The list 310 includes an OK button 331. If the user presses the button 331, the maintenance plan recording unit 60 records the setting content in the maintenance plan record DB 112.

The list 310 includes a cancel button 332. If the user presses the button 332, the maintenance plan recording unit discards the set content, and the screen is ended.

According to the present embodiment, the user can select the operation mode in which the maintenance operation can be executed while securing the required transportation capacity from the operation mode candidate display screen, and can ascertain the segment in which the maintenance operation can be executed. The user can ascertain the maintenance operation items in the segment by displaying the maintenance target candidate display screens for the operation modes selected from the operation mode candidate display screen. It is possible to select the maintenance operation performed in actuality from the listed maintenance operation items in terms of “operating rate is low (the number of failures is large)”, “inspection deadline approaches”, “there is inventory of device” and “maintenance operation can be completed in time when vehicle is operated in operation mode”. Since the maintenance cost required for the selected maintenance operation, the fare income, the operation cost and the total income and expenditure are displayed, it is possible to manage the cost of the maintenance operation. For example, since the number of workers required for the maintenance operation is displayed, it is possible to manage the required worker in the way that the worker who are not assigned to the operation can be assigned to the maintenance operation.

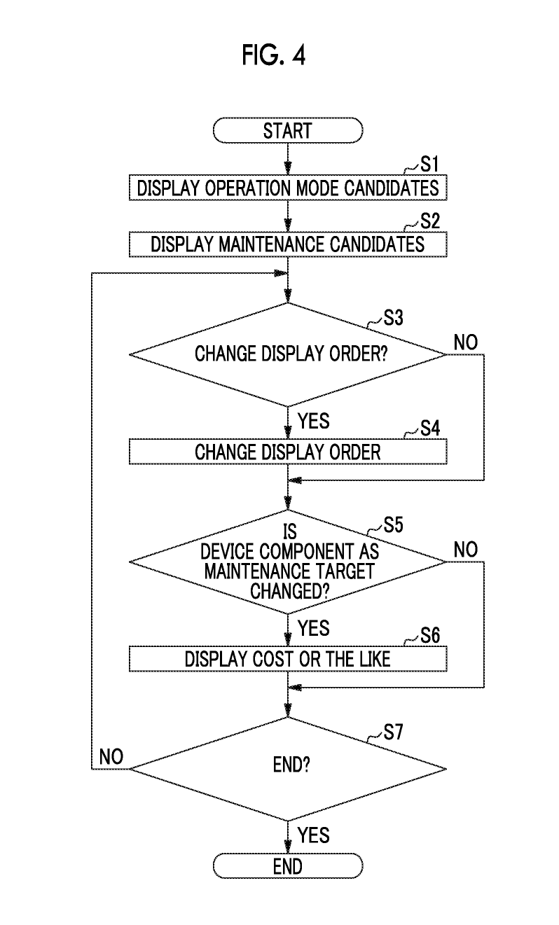

FIG. 4 is a flowchart showing a process of selecting the maintenance target according to the first embodiment of the present invention.

The process of selecting the maintenance target according to the present embodiment will be described with reference to FIG. 4.

Initially, the operation mode candidate determination unit 10 searches the operation mode DB 103 by using the condition such as the operation segment of the vehicle designated by the user, the operation date, the operation time zone, or the transportation capacity as a search condition, and reads the operation mode that satisfies the condition. The operation mode candidate determination unit 10 outputs information regarding the read operation mode to the output unit 80. The output unit 80 displays the list of the operation mode candidates shown in FIG. 2 on the display of the maintenance management device (step S1).

Subsequently, if the operation mode is selected through a predetermined operation of the user, the output unit 80 displays the maintenance target candidate display screen shown in FIG. 3 (step S2). Specifically, the maintenance target device candidate determination unit 20 initially obtains information regarding the station or operation route of the operation mode selected by the user from the operation mode candidate determination unit 10, and outputs the obtained information to the output unit 80. The output unit 80 displays the information (reference numeral 203, 204, 205 or 206) regarding the station or operation route of the screen shown in FIG. 3. The maintenance target device candidate determination unit 20 outputs a value obtained by multiplying the fare information read from the fare income DB 110 and the prediction value of the number of passengers read from the passenger number prediction data DB 109 to the output unit 80. The output unit 80 displays the obtained information on the “prediction income” field 321 of FIG. 3. The maintenance target device candidate determination unit 20 outputs a value obtained by adding the values, which are obtained by multiplying the labor cost read from the operation mode DB 103 and the expected power consumption read from the power consumption expectation cost DB 111 by the electric charges, to the output unit 80. The output unit 80 displays the obtained value in the “predicted operation cost” field 322 of FIG. 3.

The maintenance target device candidate determination unit 20 reads the information regarding the maintenance operation item in which the maintenance can be executed in the operation mode selected by the user from the executable maintenance DB 104. The maintenance target device candidate determination unit 20 reads the time required for the operation from the required maintenance time DB 106 for each read maintenance operation item, and outputs the read time to the output unit 80. The maintenance target device candidate determination unit 20 reads the number of workers required for the operation from the required maintenance worker number DB 105 for each read maintenance operation item, and outputs the read worker number to the output unit 80. The maintenance target device candidate determination unit 20 reads the cost required for the operation from the maintenance cost DB 108 for each read maintenance operation item, and outputs the read cost to the output unit 80. The maintenance target device candidate determination unit 20 reads the amount of inventory or whether or not there is inventory of the device or component from the required device component DB 107, and outputs the read information to the output unit 80. The inspection deadline is read from the inspection target priority DB 102, and is output to the output unit 80. The maintenance target device candidate determination unit 20 outputs the operating rate calculated by the operating rate calculation unit 30 to the output unit 80. The output unit 80 displays the information items obtained from the maintenance target device candidate determination unit 20 in the respective row of the list 310 of FIG. 3.

If the output unit 80 displays the candidates of the maintenance operation items, the operation detection unit 90 detects a selection operation of the maintenance target or a rearrangement operation of the maintenance items, which is performed by the user. The rearrangement operation will be described. The operation detection unit detects whether or not there is the rearrangement operation of the operating rate, the maintenance cost or the inspection deadline, which is performed by the user (step S3). For example, the rearrangement operation may be performed by continuously pressing twice (double-click) the header column of the “operating rate” using the mouse in a case where the rearrangement in the “operating rate” is performed. If the rearrangement operation is detected (step S3=Yes), the operation detection unit 90 designates an item to be rearranged, and outputs rearrangement instruction information to the output unit 80. The output unit 80 rearranges the information items of the list 310 of FIG. 3 in the designated item, and displays the rearranged information items (step S4). For example, in a case where the rearrangement in the “operating rate” is performed, the operating rates rearranged in ascending order may be displayed. For example, in a case where the rearrangement in the “inspection deadline” is performed, the inspection deadlines rearranged in approaching order may be displayed. An operation of determining the maintenance items desired to be preferentially executed by the user is more easily performed by rearranging the operating rates, maintenance costs or inspection deadlines.

In a case where the operation detection unit 90 does not detect the rearrangement operation (step S3=No), the process proceeds to step S5.

The operation detection unit 90 detects whether or not there is the selection operation of the maintenance operation items which is performed by the user (step S5). The selection operation is an operation of giving the check mark to the “selection” row of the column in which the selected maintenance operation items are displayed. If the selection operation is detected (step S5=yes), the operation detection unit 90 outputs information indicating the selected maintenance operation items to the cost information calculation unit 40. The cost information calculation unit 40 outputs the total maintenance cost value obtained by adding the maintenance costs of the selected maintenance items to the output unit 80. The cost information calculation unit 40 outputs the income and expenditure amount obtained by subtracting the predicted operation cost and the total maintenance cost value from the predicted income to the output unit 80. The output unit 80 displays the total maintenance cost value in the total maintenance cost field 325. The output unit 80 displays the time and the total number of worker required for the maintenance operation in the respective total fields 323 and 324. The output unit 80 displays the calculated income and expenditure amount in the predicted income and expenditure 326 (step S6). The user can draft the maintenance operation plan while preventing a deficit by displaying the total maintenance cost and the income and expenditure amount depending on the selected maintenance items. The user can draft an executable maintenance operation plan or a reasonable required worker number plan by displaying the time or worker number required for the maintenance operation depending on the selected maintenance operation items.

Thereafter, the operation detection unit 90 detects whether or not there is an end operation which is performed by the user (step S7). For example, the end operation is performed through the pressing of the OK button 331 or the cancel button 332 by the user. If the pressing of the OK button by the user is detected, the operation detection unit 90 transmits a recording instruction to the maintenance plan recording unit 60. By doing this, the maintenance plan recording unit 60 records the operation mode selected by the user, the maintenance operation item, the time required for the operation, the number of workers, the maintenance cost and the income and expenditure amount information in the maintenance plan record DB 112. If the end operation is detected, the operation detection unit 90 outputs an end instruction to the output unit 80, and the output unit 80 ends the displaying of the maintenance target candidate display screen. The present process flow is ended.

The maintenance management device of the present embodiment uses data items such as an operation schedule, component failure history, component inventory information, worker attendance and absence information, and cost or fare income, which are individually accumulated, and displays information required to draft the maintenance operation plan, as a list, by sorting and associating these information items with one another. The user can efficiently execute the maintenance operation.

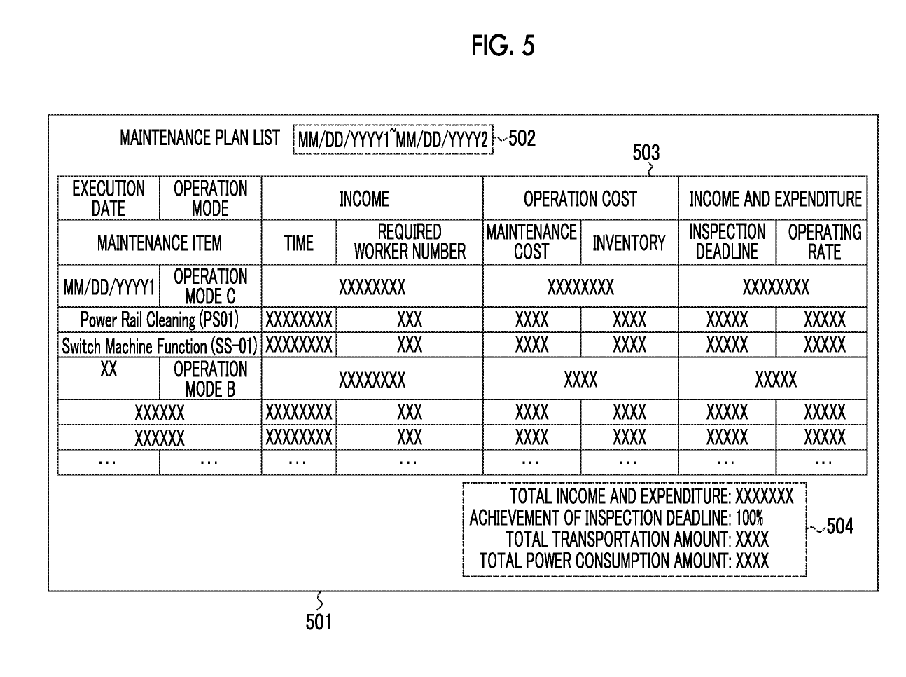

FIG. 5 shows an example of a maintenance plan list according to the first embodiment of the present invention.

A maintenance plan list 501 shown in FIG. 5 is a list that outputs the maintenance operation items planed to be executed for a predetermined period (for example, one month), and the cost or the number of workers required for each maintenance operation item by using the information which is recorded in the maintenance plan record DB 112 and is read by the maintenance plan list creation unit 70. The maintenance plan list 501 includes a predetermined period 502 designated as a list output target by the user. The maintenance plan list 501 includes a list 503 displayed by collecting the contents of the maintenance operations selected on the maintenance target candidate display screen by the user for each operation mode. The maintenance plan list 501 includes an area 504 in which a total income and expenditure amount, a total transportation amount, a total power consumption amount, and a ratio at which the device or component that meets the inspection deadline within the predetermined period can achieve the inspection deadline are displayed.

The user can ascertain whether or not the required transportation amount can be achieved, the cost required for the maintenance operation or the power consumption amount by referring to this list. The user can draft a long-term required worker plan, or can check whether or not an inspection cycle can be achieved on the plan.

Although an example in which all the inspection deadline can be achieved is displayed in the list shown in FIG. 5, the list of devices or component may be displayed on a lower side of the list of FIG. 5 in a case where there are devices or components that are not planned for the maintenance operation even though the devices or components meet the inspection deadline within the predetermined period. The maintenance plan list creation unit 70 compares the devices or components extracted by the maintenance necessary target extraction unit 50 using the predetermined period as the condition with the information recorded in the maintenance plan record DB 112, and thus, information regarding the devices or components that are not planned for the operation can be specified. The user can ascertain whether or not the maintenance operation item for the device or component lacks by checking “achievement of inspection deadline” of this list.

The above-described maintenance management device includes a computer therein. The respective processes of the above-described maintenance management device is stored as programs in a computer readable recording medium, and the processes are performed by reading and executing the programs in the computer. The computer readable recording medium mentioned herein refers to a magnetic disc, a magneto-optical disk, a CD-ROM, a DVD-ROM, or a semiconductor memory. The computer programs may be transmitted to the computer through a communication line, and the computer that receives the program may execute the program.

The program may be implemented using a part of the above-described functions.

The program may be implemented by combining the above-described function with a program already recorded in a computer system, or may be a so-called differential file (differential program).

In addition, the constituent elements of the above-described embodiments may be appropriately replaced with the known constituent elements without departing the gist of the present invention. The technical scope of the present invention is not limited to the above-described embodiments, and may be variously modified without departing the gist of the present invention.

### INDUSTRIAL APPLICABILITY

According to the maintenance management device, the maintenance management method, and the program, it is possible to efficiently perform the maintenance operation plan.

### REFERENCE SIGNS LIST

10: operation mode candidate determination unit
20: maintenance target device candidate determination unit
30: operating rate calculation unit
40: cost information calculation unit
50: maintenance necessary target extraction unit
60: maintenance plan recording unit
70: maintenance plan list creation unit
80: output unit
90: operation detection unit
101: device failure history DB
102: inspection target priority DB
103: operation mode DB
104: executable maintenance DB
105: required maintenance worker number DB
106: required maintenance time DB
107: required device component DB
108: maintenance cost DB
109: passenger number prediction data DB
110: fare income DB
111: power consumption expectation cost DB
112: maintenance plan record DB

1. A maintenance management device of a track running vehicle system, comprising:
a maintenance target device candidate determination unit that determines maintenance target device candidates in a maintenance segment based on an operation mode determined for the track running vehicle system; and
an output unit that outputs the determined maintenance target device candidates.

2. The maintenance management device according to claim 1, further comprising:
an operating rate calculation unit that calculates an operating rate of each maintenance target device candidate based on past operation time and failure history,
wherein the output unit outputs the operating rate of each maintenance target device candidate.

3. The maintenance management device according to claim 1, further comprising:
a cost information calculation unit that calculates cost information based on maintenance cost of a maintenance target device selected from the maintenance target device candidates,
wherein the output unit outputs the maintenance cost and the cost information of each maintenance target device candidate.

4. The maintenance management device according to claim 1,
wherein the output unit obtains an inspection deadline of each maintenance target device candidate, and outputs the obtained inspection deadline.

5. The maintenance management device according to claim 2,
wherein the output unit rearranges the maintenance target device candidates based on at least one of the operating rate, the maintenance cost and the inspection deadline, and displays the rearranged maintenance target device candidates.

6. The maintenance management device according to claim 1,
wherein the output unit obtains the amount of inventory of each maintenance target device candidate, and outputs the obtained amount of inventory.

7. The maintenance management device according to claim 1,
wherein the output unit obtains time and the number of workers required for maintenance of each maintenance target device candidate, and outputs the obtained time and number of worker.

8. The maintenance management device according to claim 1, further comprising:
an operation mode candidate determination unit that determines candidates of the operation mode indicating a vehicle operation mode in a predetermined operation segment and a predetermined operation time zone,
wherein the output unit outputs the candidates of the operation mode in the predetermined operation segment and the predetermined period.

9. The maintenance management device according to claim 1,
wherein the output unit performs display such that an operation route and a maintenance segment are different for an operation mode selected from the candidates of the operation mode.

10. The maintenance management device according to claim 1, further comprising:
a maintenance plan recording unit that records information including the maintenance target device selected for each operation mode and the maintenance cost and the number of workers for the maintenance target device,
wherein the output unit obtains the information recorded by the maintenance plan recording unit, and outputs the achievement of the inspection deadline which is previously determined for each maintenance target device candidate and total income and expenditure calculated using a fare income, operation cost and maintenance cost for a predetermined period.

11. A maintenance management method in a track running vehicle system, comprising:
determining maintenance target device candidates in a maintenance segment based on an operation mode determined for the track running vehicle system; and
outputting the determined maintenance target device candidates.

12. A program causing a computer of a maintenance management device to function as:
means for determining maintenance target device candidates in a maintenance segment based on an operation mode determined for a track running vehicle system; and
means for outputting the determined maintenance target device candidates.
